(19) United States
(12) Patent Application Publication
(10) Pub. No.: US 2021/0311085 A1
(43) Pub. Date: Oct. 7, 2021

(54) PROGRAMMABLE FLUID DISTRIBUTION SYSTEM

(71) Applicant: Rustam YUKHANANOV, Mansfield, MA (US)

(72) Inventor: Rustam YUKHANANOV, Mansfield, MA (US)

(21) Appl. No.: 17/219,384

(22) Filed: Mar. 31, 2021

Related U.S. Application Data
(60) Provisional application No. 63/003,537, filed on Apr. 1, 2020.

(51) Int. Cl. G01N 35/10

(52) U.S. Cl. CPC G01N 35/1002; G01N 2035/00524; G01N 35/1004

(57) ABSTRACT

The present inventive concept is an apparatus for programmable fluid delivery and may be used for different detection assays and test that use flow lines for multiple reagents and a tray base with trays coming in multiple sizes. The inventive concept may be used for procedures such as producing biological assay, the procedures using flow lines to carry multiple reagents. The inventive concept has manual and automated settings and is designed to impart either or both vertical up and down motions or horizontal side to side motions on the tray. Valve members are placed parallel to each other instead of all in a line, the valve system controlling and discharging fluid controlled by a set of programmable pinch valve assemblies that pinch or release multiple elastomeric flow conduits.

### CLAIM OF PRIORITY

This application claims priority to and the benefit of U.S. Provisional application with Ser. No. 63/003,537, filed on Apr. 1, 2020, which is incorporated herein by reference in its entirety.

### FIELD OF THE INVENTION

The present inventive concept relates to an assay apparatus used to efficiently detect materials such as proteins when diagnosing infections or diseases.

### BACKGROUND

An assay is an analytic procedure in medicine used to assess or quantitatively measure the presence, amount, or functional activity of a target entity. An assay usually aims to measure the properties of a target entity and express those properties in the relevant measurement units. Assay automation can improve a lab's efficiency, throughput, data quality, and permit scientists more time for non-routine tasks. But current systems and methods may be complex and expensive. So, there is a need in the market for an improved automated array that offers the precision of current automated assay systems but is less complex to make and operate.

### SUMMARY OF THE INVENTION

The object of the present inventive concept is to provide economical and efficient passageways through conduits to discharge reagents and liquid to and from reaction chambers that ensure better maintenance of the passageways when producing assays.

One object of the present inventive concept is to store reusable plastic vials and fill the reusable plastic vials with liquid reagents.

Another object of the present inventive concept is to allow a tray to automatically change from either or both horizontal and rocking agitations.

Another object of the present inventive concept is to allow, for example, the uninterrupted cycle of automated assays by excluding from the cycle of cleaning reagent containers.

Another object of the present inventive concept is to diminish the number of valves required to open or close the passageways through the conduits to discharge the reagents and wash liquid from reaction chambers.

Another object of the present inventive concept seeks to provide an automated assay apparatus with relatively fewer components than the current state-of-the-art, for example, by utilizing a washing jar of relatively smaller volume when compared to an otherwise oversized and complex washer tank.

Another object of the present inventive concept is to simplify supplying of washer liquid to the reaction chambers by using, for example, a pump with a controlled volume delivery.

Another object of the present inventive concept is to ease installing trays of different sizes on the agitation table.

Another object of the present inventive concept is to allow the torsion springs of each valve to pinch the conduit without restrictions by other valves of the set.

Another object of the present inventive concept is the provision for the user to change the agitation method to either or both horizontal front and back motions and vertical up and down motions in one agitation cycle.

There is provided an automated assay apparatus for performing one or more assay procedures using liquid reagents. The apparatus has a first vial supporting plate; a first vial designed to be filled with the liquid reagent; a first funnel designed to accept the liquid reagents; a first reaction chamber; a first elastomeric conduit comprising a passageway, a first end of the passageway in communication with the first funnel; a plurality of parallelly aligned valve members; and a second end of the passageway communicatively coupled with the first reaction chamber.

In one embodiment of the automated assay apparatus, the first vial supporting plate is designed to accept the first vial and is further designed to be inclined to pour the liquid reagent out to the first funnel; and the first elastomeric conduit is designed to deliver the liquid reagent from the first funnel to the first reaction chamber. In this embodiment of the automated assay apparatus, the vial supporting plate may further include at least one first cell member to place the vial, a cut portion or a round opening to install the vial, the first cell member designed to compress against the vial body, and side boss members to hold the vial in position during the plate rotation, and lower round boss members used as shafts around which the plate rotates, and upper round boss members used to push the plate and cause the plate to rotate. This embodiment of the automated assay apparatus may further include a drive mechanism designed to rotate the vial supporting plate, further including a means designed to rotate the supporting plate of the vials.

One embodiment of the automated assay apparatus further has a supply vessel filled with a liquid reagent; a plate designed to cover the first funnel; the cover plate containing a first hollow passageway; a second elastomeric conduit, a first end of the second elastomeric conduit communicatively coupled with the reagent supply vessel, and a second end of the second elastomeric conduit communicatively coupled with the first hollow passageway; the first hollow passageway formed in the cover plate to supply reagent liquid to the first funnel and direct the reagent liquid to wash the first funnel walls.

One embodiment of the automated assay apparatus further has an agitating table to shake the reaction chambers, the agitating table having one round horizontal guide bar designed to hold and allow the reaction chambers to move in one horizontal direction, and further having a driving mechanism designed to restrict the rotating motion around the round horizontal bar. In this embodiment of the automated assay apparatus, the driving mechanism may be designed to supply the agitating table with a combined rotation around the guide bar and longitudinal shaking of the reaction chambers, the driving mechanism having one round horizontal guide designed to hold and allow the reaction chambers to move. In this embodiment of the automated assay, the driving mechanism may be designed to supply the agitating table with selectable motions that involve combining the rotation around the guide bar and the longitudinal shaking, or involve rotating around the guide bar only, or involve longitudinal shaking only, the drive mechanism movable along the agitating cam axis double rectangular cam followers. This embodiment of the automated assay apparatus may further involve the agitating cam having a second radial protrusion forming a second cam profile that engages with the first end of a second elongated member. Each of a first and the second elongated members may be a plastic rod. The first and second valves may each include a spring, the springs being torsion springs.

The inventive concept now will be described more fully hereinafter with reference to the accompanying drawings, which are intended to be read in conjunction with both this summary, the detailed description, and any preferred and/or particular embodiments specifically discussed or otherwise disclosed. This inventive concept may, however, be embodied in many different forms and should not be construed as limited to the embodiments set forth herein; rather, these embodiments are provided by way of illustration only and so that this disclosure will be thorough, complete, and will fully convey the full scope of the inventive concept to those skilled in the art.

### BRIEF DESCRIPTION OF THE DRAWINGS

The present inventive concept will be more fully understood with reference to the accompanying drawings in which:

FIG. 1 is a perspective view of one embodiment of the apparatus according to the present inventive concept.

FIG. 2 is a perspective view of one embodiment of a plastic threaded vial with a cap, that provides possibilities to store liquid reagent and use them as filled supply vessels;

FIG. 3A is a perspective view of one embodiment of a reagent supply unit;

FIG. 3B is a perspective view of one embodiment of a vials support swing plate;

FIG. 3C is a fragmentary, perspective view of an exemplary embodiment of a reagent supply mechanism;

FIG. 3D is a perspective view of one embodiment of a reagent supply unit and illustrates the process of supplying the liquid reagent to the reaction chamber;

FIG. 4A is a perspective view of a tray agitating table with a large-sized tray installed;

FIG. 4B is a prospective view of the tray agitating table with a middle-sized tray installed and illustrates the possibility of changing trays on the present embodiment of the agitating table FIG. 4A;

FIG. 4C is a fragmentary perspective view of the agitating table that illustrates the portions of tray agitating and valve opening mechanisms and illustrates the present embodiment of agitating table FIG. 4A;

FIG. 4D is a fragmentary perspective view of the agitating table that illustrates the tray agitating mechanism and illustrates the present embodiment of the agitating table FIG. 4A;

FIG. 4E is a fragmentary perspective view of the agitating table that illustrates the valve opening mechanism and illustrates the present embodiment of the agitating table FIG. 4A;

FIGS. 5A, 5B, 5C, and 5D are fragmentary perspective views of the agitating table that illustrate the portions of tray agitating mechanisms and illustrate the exemplary embodiment of the agitating table mechanism that allow manually selecting one available agitating motion: 1) horizontal, front and back, 2) vertical up and down, or 3) both in one cycle;

FIGS. 6A, 6B, and 6C illustrate a method for using the automated assay apparatus.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

The present inventive concept is directed to an automatic assay apparatus that comprises an assembly of liquid reagent vessels; logic control units; trays of different sizes agitating either horizontally, rocking, or simultaneously horizontally and rocking; multiple elastomeric conduits connecting the supply and target vessels controlled by an assembly of pinch valves independently closing or releasing elastomeric flow conduits passageways.

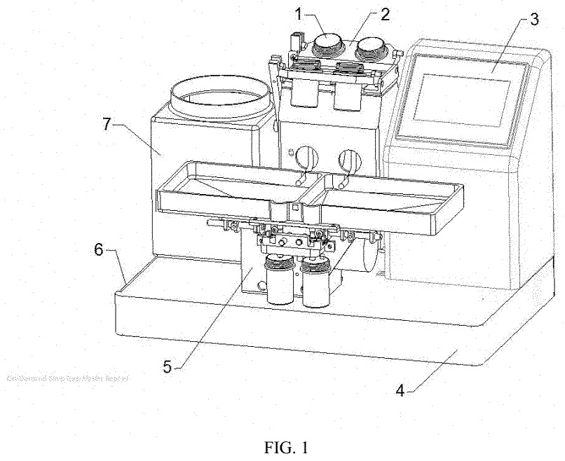

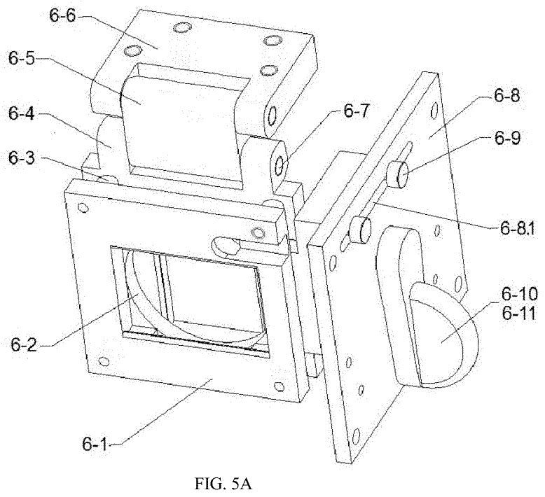

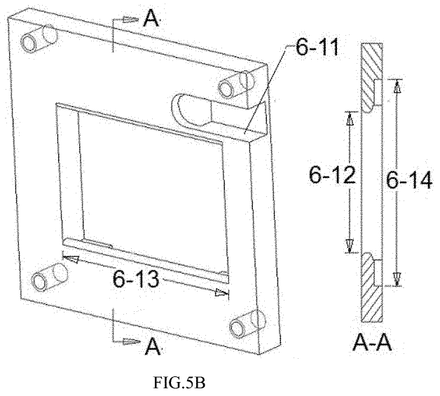

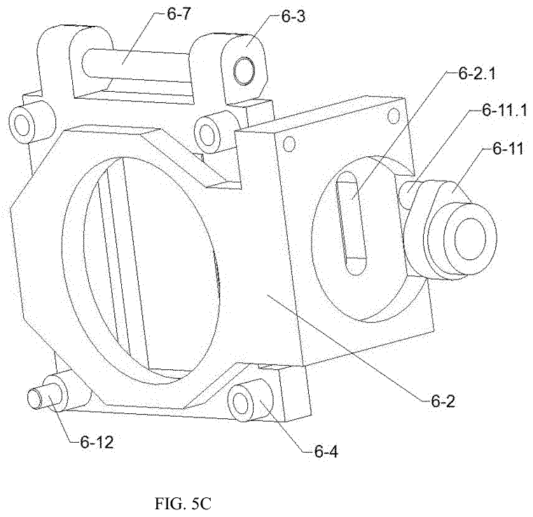

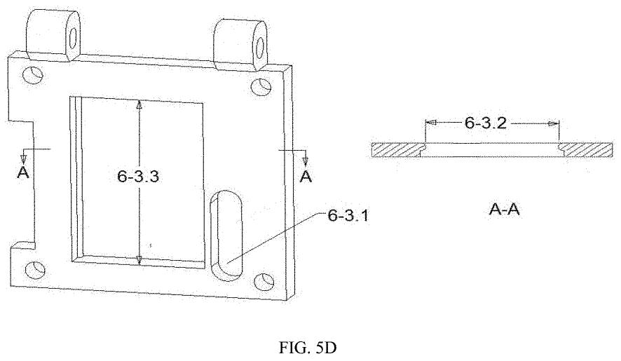

FIG. 1 discloses the preferred embodiment of the major components of the automated assay apparatus, designated from 1 through 6. A component designated 1 is a standard vial. A reagent supply unit 2 is designed to supply reagents to, with reference to FIG. 5A, a reaction chamber 5-21. Vials are placed in a specially designed supporting plate designed for easing installing vials on those plates of the reagent supply unit 2. The reagent supply unit 2, an electric control unit 3, a tray agitating table 5, and a containing washer liquid, jar 7, are mounted on a base 4. Reagents discharge collecting tray 6 is installed inside the base 4. The exemplary embodiment has four vials 1 filled with reagents. Control functions are performed by the electric control unit 3, containing a processor and display unit that allows change of an existing program or the addition of a new one.

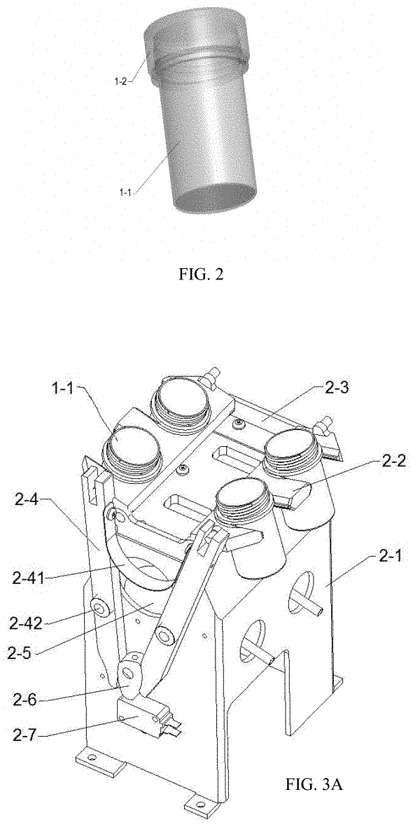

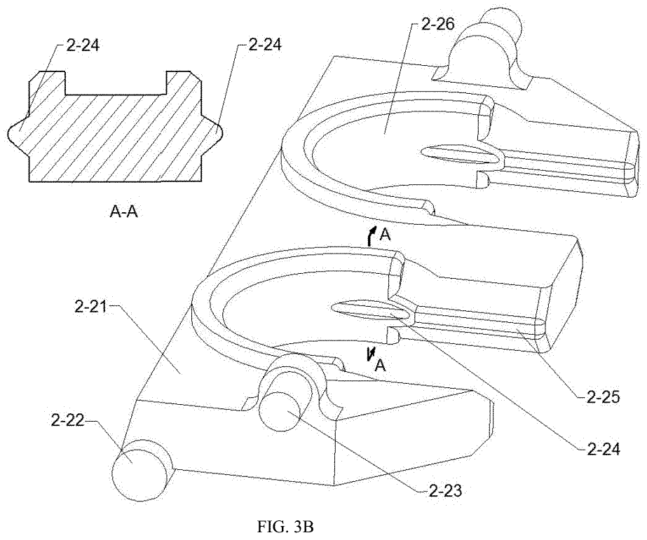

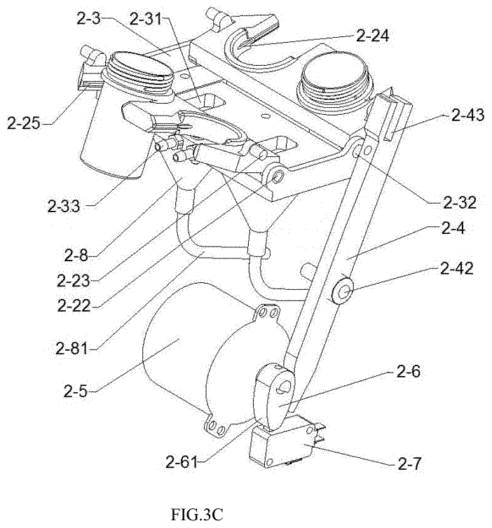

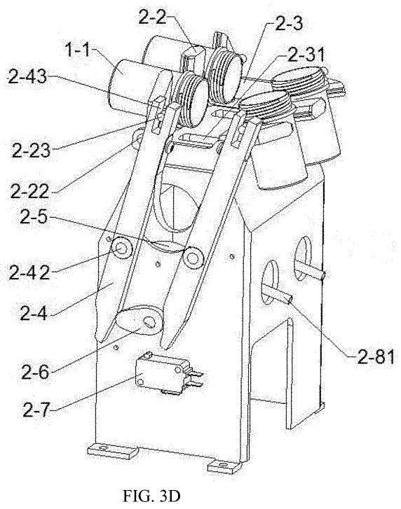

FIG. 2 is a perspective view of a plastic threaded vial, designated 1-1 and a cap, designated 1-2. The cap is used when the vial 1-1 is filled with liquid reagent to store. The cap is removed when the vial is installed on the supply unit, FIG. 3A.

FIG. 3A is a perspective view of one embodiment of the reagent supply unit. The process of supplying reagent to the reaction chambers consists only of one motion. That motion is to rotate a vial supporting plate, designated 2-2, in a position to empty the vials, 1-1; Cam 2-6 (mounted on a shaft of an electrical motor 2-5) illustrated on a starting position, contacting a switch, 2-7, rotated by a motor 2-5. FIG. 3D illustrates the process of supplying the liquid reagent to the reaction chamber.

FIG. 3B is a perspective view of one embodiment of the vial supporting plate, 2-2, and illustrates cells used to place vials, designated 2-26, cuts to ease installment of the vials, designated 2-25, by partly compressing its body (1-1, FIG. 2), and side boss members, 2-24, to hold the vials in position during the plate rotation. Lower round boss members 2-22 are used as shafts around which the plate is rotated, and boss members 2-23 are used to push the plate to rotate.

FIG. 3C illustrates a fragmentary (the column 2-1, FIG. 3A is not illustrated) view of one embodiment of a chain to rotate the vial supporting plate, 2-2, containing a cam, 2-6, two levers, 2-4, engaged with the cam and the upper round boss members 2-23 of the supporting plate and mounted on axes 2-42 to allow the plate to rotate around them. Also FIG. 3C illustrates the passages used for delivering the reagents and washer liquids to the reaction chambers, consisting of funnels, designated 2-8, mounted on the column and covered by a cover plate 2-3. Funnels are connected to the reaction chambers by tubes, designated 2-81. The washer liquid is delivered by a pump that is coupled to adapters 2-33 and a channel that is placed so that the reagent washes both funnels and moves farther to the reaction chambers of the trays.

FIG. 3D is a perspective view of one embodiment of the reagent supply unit and illustrates the process of supplying the liquid reagent to the reaction chamber. The motor 2-5, turns the cam 2-6 clockwise the first time and counterclockwise the second (if there are only two reagent liquids). FIG. 3D further illustrates the cam surface 2-61. 2-6 pushes the lever 2-4 around the axis 2-42. Slot 2-43 of the lever 2-4 engages with the upper round boss member 2-23 of the plate 2-2, so when the lever turns, the vial supporting plate 2-2 rotates toward the center of the column. The reagent liquid drops through the openings 2-31 in the cover plate 2-3 directly to the funnels 2-8 and follows through tubs 2-81 to the reaction chambers.

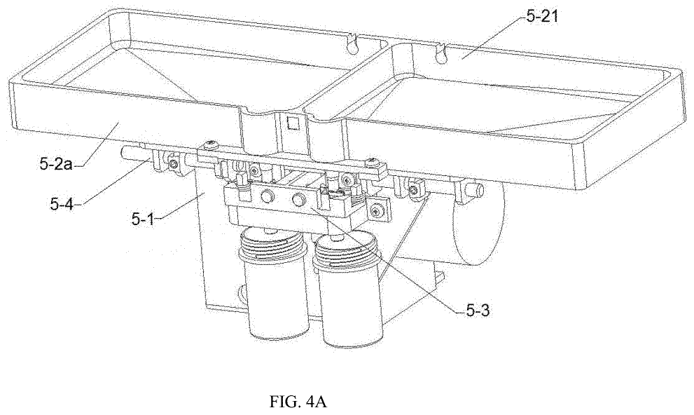

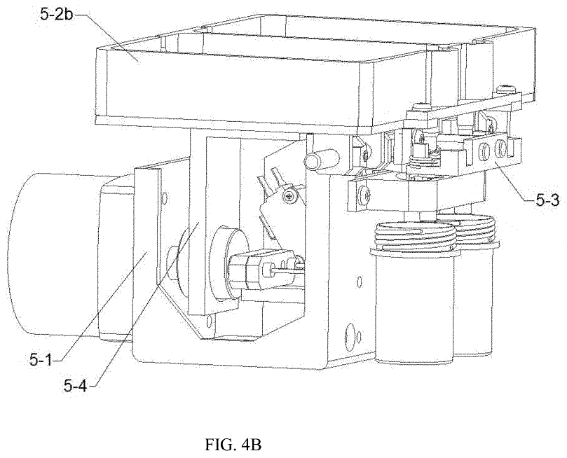

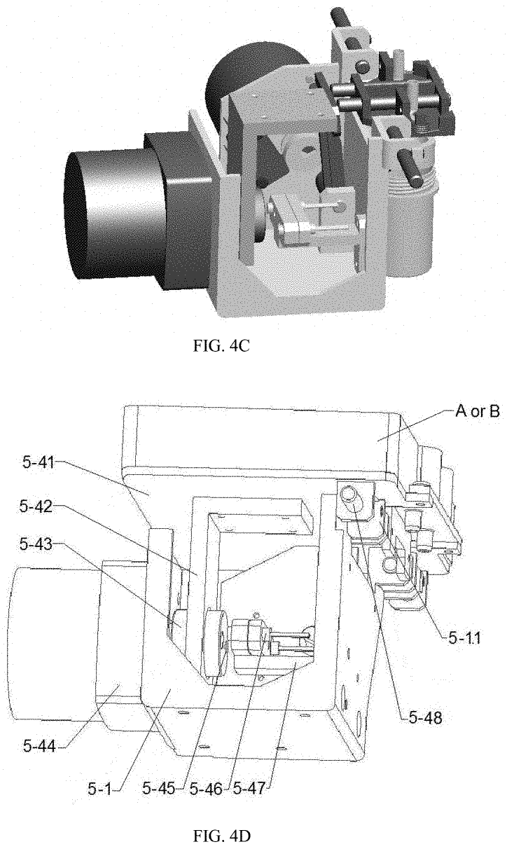

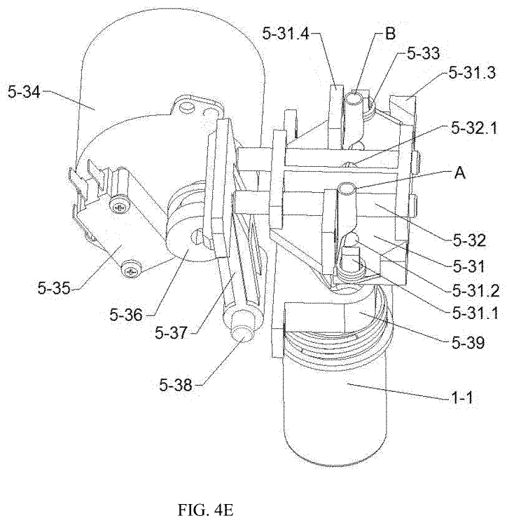

FIG. 4A is a perspective view of the tray agitating table 5 with a large size of the tray installed. The preferred embodiment uses different sizes of trays for different sizes of reaction chambers. FIG. 4A further illustrates, as an example, the use of a tray, designated 5-2a, installed on an agitation mechanism 5-4. The dimensions of the reaction chambers for this tray, designated 5-21, are 15×10 cm. each. Illustrated also is a mechanism, designated 5-3, to control the discharge of the reagents from the reaction chambers. FIGS. 4D and 4E discloses in greater details the preferred design of these mechanisms.

FIG. 4B is a perspective view of the preferred embodiment of the tray agitating table when installed, for example, the tray, designated 5-2b, with the reaction cambers dimensioned at 10×8 cm.

FIG. 4C is a partially shaded perspective view of the preferred embodiment of the tray agitating table. The tray base plate is not illustrated. Illustrated in greater details are the mechanism 5-3, to control the discharge of the reagents from the reaction chamber, and the tray agitation mechanism 5-4.

FIG. 4D is a partial perspective view of the preferred embodiment of the tray agitating table. The mechanism to control the discharge of the reagents from the reaction chamber 5-3 is not illustrated. Illustrated in greater details are the agitation mechanism 5-4, an exemplary design of the agitation table: the tray agitation mechanism 5-4. To make this exemplary design of the agitation table possible, only one horizontal round guide bar is used, designated 5-48. The bar 5-48 is mounted and fixed inside a bracket 5-1.1 of the table base 5-1. This embodiment allows the tray support base 5-41 to be mounted on table base 5-1, the tray A or B designed to move horizontally along the bar 5-48, and, simultaneously, swing around the bar 5-48, up and down. The other support prevents the tray from performing uncontrolled swing motions and uses the oscillation of cam 5-43, mounted on a shaft of the motor 5-44. The cam is the source of the horizontal and rotary tray agitating motion, through a bracket 5-42. Two magnetic sensors 5-46, mounted on another bracket 5-46, are attached to the table base 5-1, and a small round magnet bar 5-45, the magnet bar 5-45 inserted in the cam 5-43 hole, controls both ends of the horizontal motion.

FIG. 4E illustrates a partial perspective view of the preferred embodiment of the mechanism 5-3, used to control the discharge of the reagent and washer liquid from the reaction chamber. The tray agitation mechanism 5-4, and table body 5-1, are not illustrated. FIG. 4E further illustrates an exemplary design of the valve assembly unit that includes two valves, a number, corresponding to the number of reaction chambers 5-21, placed on one body 5-31 that has one stud, designated 5-31.1, one lug 5-31.3, and one rigid vertical abutment 5-31.4 for each valve. Flexible flow conduits, designated A and B, are threaded through passageways 5-31.2. Round bars 5-32 are threaded with the possibility of moving along their axes through guide way holes at front and back walls of the body. Torsion springs, designated 5-33, are loosely seated on studs 5-31.1, with one leg fixed against lugs 5-31.3 of the housing; while the other leg is directed perpendicular to the axis of the conduit and pinches the conduit by pressing the conduit to the abutment 5-31.4, forming the pressed part of the conduits A and B and preventing the fluid flow. Further, these legs extend through the holes in the bars 5-32.1. The motions to open the valves are substantially the same as the motions of the reference patent U.S. Pat. No. 8,758,687. Different is that the valves are placed parallel to each other instead of inline as on the reference patent U.S. Pat. No. 8,758,687. This frees the torsion springs to pinch the flexible flow conduits without restrictions that may otherwise be put on the binding of all springs if configured in a line by one round pushing bar. The benefit of this parallel configuration is that the valves can be produced less precisely than in the inline configuration. Components: motor 5-34, cam 5-36, switch 5-35, and lever 5-37 perform the substantially same motion according to the program as the motion programmed in the reference patent U.S. Pat. No. 8,758,687.

A structure component, designated FIG. 5-39, placed under the block of valves, is used to divide the discharge liquid flow into two places: first—a washer and some reagent liquid to the collecting tray, designated 6, FIG. 1; second—into two vials 1-1, installed under the component 5-39, and used to collect valuable reagents. A division of the liquid flow is performed, according to the program, when the tray is placed at the right or left end of the horizontal motion, wherein the mechanism 5-3 releases the conduits A and B.

FIGS. 5A, 5B, 5C, and 5D are fragmentary perspective views of the agitating table that illustrate portions of tray agitating mechanisms, designated 6.0, illustrating the exemplary embodiment of the agitating table mechanism that allows manually selecting one available agitating motion: horizontal front-and-back, vertical up-and-down, or both in one cycle. This agitating motion is made available by replacing the one rigid part cam follower bracket 5-42 on FIG. 4D that provides for combining two agitating motions, horizontal and vertical, into one agitation cycle, by an assembly containing two parts operably coupled to the agitating cam 5-43, FIG. 4D. One, vertical cam follower 6-1, contacts the Cam only by horizontal, upper, and bottom points, the other, horizontal cam follower 6-4, contact the cam only by vertical, right, and left, points. Both parts are rigidly coupled to each other through parts 6-3 which provides a space between the vertical cam follower and the horizontal cam follower for part 6-2, which serves as a Bracket that holds the cam followers vertically, providing free motion for the cam followers in a vertical plane, and horizontal motion along the agitating cam 5-43. The bracket 6-2 is attached to a Plate 6-8 by shoulder screw 6-9 with a provision to horizontally move along the slot 6-8.1. This horizontal motion is activated by rotating agitating type selecting cam 6-11, both 6-11.1 of which engage with Slot 6-2.1 and guide the bracket and cam followers into place in 3 different positions: 1) to an extreme left position—when the horizontal motion is selected, 2) to a center position—when both motions are needed, and 3) to a right position—when a rocking motion is needed. The selection of a position can be done by rotating the handle 10 (manually) or by installing an electrical motor (automated) instead of the handle.

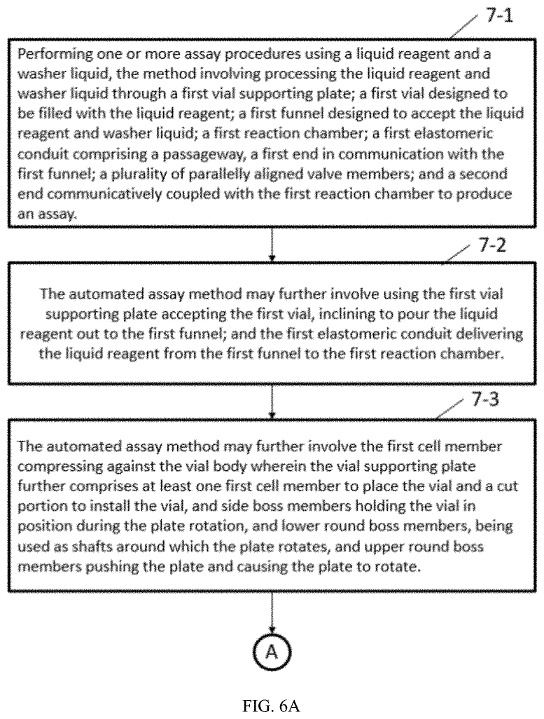

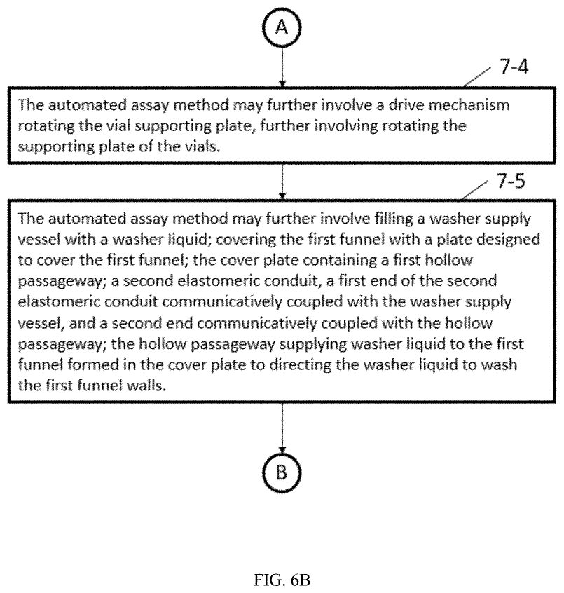

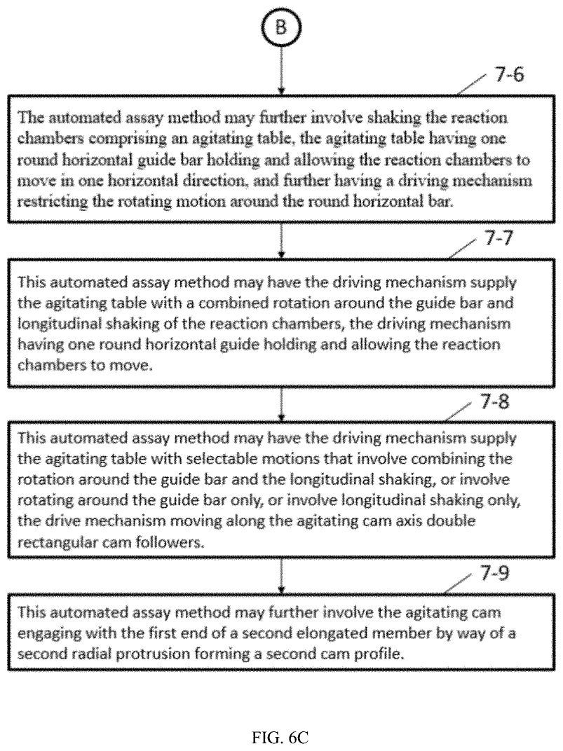

FIG. 6A-6C illustrate an automated assay method for performing one or more assay procedures using a liquid reagent and a washer liquid, the method involving processing the liquid reagent and washer liquid through a first vial supporting plate; a first vial designed to be filled with the liquid reagent; a first funnel designed to accept the liquid reagents; a first reaction chamber; a first elastomeric conduit comprising a passageway, a first end of the passageway in communication with the first funnel; a plurality of parallelly aligned valve members; and a second end of the passageway communicatively coupled with the first reaction chamber to produce an assay 7-1.

The automated assay method may further involve using the first vial supporting plate accepting the first vial, inclining to pour the liquid reagent out to the first funnel; and the first elastomeric conduit delivering the liquid reagent from the first funnel to the first reaction chamber 7-2.

The automated assay method may further involve the first cell member compressing against the vial body wherein the vial supporting plate further comprises at least one first cell member to place the vial and a cut portion to install the vial, and side boss members holding the vial in position during the plate rotation, and lower round boss members being used as shafts around which the plate rotates, and upper round boss members pushing the plate and causing the plate to rotate 7-3.

The automated assay method may further involve a drive mechanism rotating the vial supporting plate, further involving rotating the supporting plate of the vials 7-4.

The automated assay method may further involve filling a reagent supply vessel with a reagent; covering the first funnel with a plate designed to cover the first funnel; the cover plate containing a first hollow passageway; a second elastomeric conduit, a first end of the second elastomeric conduit communicatively coupled with the reagent supply vessel, and a second end of the second elastomeric conduit communicatively coupled with the first hollow passageway; the first hollow passageway supplying reagent (e.g, washer liquid) to the first funnel formed in the cover plate and directing the liquid to wash the first funnel walls 7-5.

The automated assay method may further involve shaking the reaction chambers comprising an agitating table, the agitating table having one round horizontal guide bar holding and allowing the reaction chambers to move in one horizontal direction, and further having a driving mechanism restricting the rotating motion around the round horizontal bar 7-6. This automated assay method may have the driving mechanism supply the agitating table with a combined rotation around the guide bar and longitudinal shaking of the reaction chambers, the driving mechanism having one round horizontal guide holding and allowing the reaction chambers to move 7-7. This automated assay method may have the driving mechanism supply the agitating table with selectable motions that involve combining the rotation around the guide bar and the longitudinal shaking, or involve rotating around the guide bar only, or involve longitudinal shaking only, the drive mechanism moving along the agitating cam axis double rectangular cam followers 7-8. This automated assay method may further involve the agitating cam engaging with the first end of a second elongated member by way of a second radial protrusion forming a second cam profile 7-9.

As described heretofore, the present inventive concept is directed to an automated assay apparatus comprising one or multiple assay blocks, each of the one or multiple assay blocks containing liquid reagents, the tray to support reactant, and the washer vessel. The inventive concept further comprises the means to automatically deliver the reagents into the tray of the block and discharge the reagents from the tray into the designated vessels in pre-programmed order. The apparatus further comprises the means to automatically deliver the reagents to the tray assembly and further includes the flexible vials, the vial supporting plates, rocking around the horizontal axis, the funnels connected to the tray, and the gear motor with a cam, and parts to transmit the rotating motion from the cam to rotate the vial supporting plates. The preferred embodiment of the inventive concept further includes the tray agitating table means that provide combined horizontal shaking and rocking movements of the trays. The means to shake the trays simultaneously horizontally and rock them around the horizontal axis includes one longitudinal axis with bearings, a gear motor with an oscillation cam drive, and parts to transmit the agitating motion from the oscillating cam to the trays.

The inventive concept further includes the means to automatically discharge the reagents from the trays is a multiple of programmable pinch valve assemblies for controlled delivery of multiple different fluids from sources to sites. The work cycle of the valves is the same as the work cycle of the referral patent, specifically pinching or releasing elastomeric flow conduits. The difference is that the valves of the inventive concept are placed parallel to each other instead of inline as on the reference patent U.S. Pat. No. 8,758,687. This parallel alignment frees the torsion springs to pinch the flexible flow conduits without restrictions that may otherwise be put on the binding of all springs when in a line by one round pushing bar. The benefit of the parallel alignment is that the valves can be produced less precisely while maintaining comparable effectiveness.

The preferred embodiment of the valve design includes a housing with plural studs and passageways, multiple elastomeric flow conduits which are threaded through the housing passageways, and actuator means located in and movable within the housing for acting against the forces of torsion springs to open selected fluid conduits. The torsion springs are loosely seated on the studs with one leg fixed to the housing while the other leg is directed perpendicular to the axis of the tube, selectively and individually pinching the conduits and preventing the fluid flow. Further, this other leg extends through the hole in the bar. The torsion springs are loosely seated on the studs to ease pivoting the spring around the stud and ease removing the torsion springs when change is necessary. The backing means are a plurality of abutments of the housing including the vertical walls adjacent to the passageways for elastomeric fluid conduits which provide sufficient resistance to accomplish a complete closing of the fluid flow through the conduits. The abutments include substantially parallel surfaces for supporting fluid conduits.

The studs and spring retaining lugs of the housing are placed row over row according to the number of sets of simultaneously activated multiples of elastomeric flow conduits. The actuator means include bars having holes normal to the axis of the bar threaded through and movable along the housing guideways and engaging with the torsion spring threaded through the holes. The means to automatically discharge the reagent and washer liquids from the trays by way of a plurality of programmable pinch valves assembled for controlled delivery of multiple different fluids from sources to sites by pinching or releasing elastomeric flow conduits further include an actuator drive that further includes: a shaft located along the housing body, a motor that rotates the shaft, a motor with a cam to supply rotating motion to the lever, and electrical switches to control the motion of the cam. The shaft bears a number of pads located near the end of the actuator. The pads translate the motion of the shaft by operably coupling the selecting actuator to force the engaged torsion spring to release selected elastomeric flow conduits. The means to automatically deliver the reagents and washer liquids into the tray of the block and discharge the reagent and washer liquids from the trays is a plurality of programmable pinch valve assemblies designed for controlling the delivery of multiple different fluids from sources to sites by pinching or releasing elastomeric flow conduits further having an actuator drive that includes: the rotatable cam coupled to the housing motor, one or more actuator means mounted on the shaft of the motor parallel to each other and perpendicular to the cam's axis of rotation, and engagement with a plurality of torsion springs used as a pinch member. The cam has extending radial protrusions which form a cam profile—a displacement profile which is placed along the axis of the cam and forms a one track or multiple track cam. The cam normally rotates in one direction but is adopted with the option to rotate in either direction as imparted from the translating motion from the actuator bars which, due to the special contour of the displacement profile, may slide either simultaneously all together or individually in programmable sequences. When the bar moves, it pushes the engaged springs away from the conduits, releasing the fluid flow. The valve is programmable by the profile tracks, the sequence of cam rotation directions, and the duration of the rotation. The cam actuator contains a number of displacement profiles for activating the movement of cam followers according to desired sequences, activating only one. The cam actuator contains an additional profile track that engages with an electric switch to control the initial position of the cam. The cam followers may contact the cam's displacement profile directly or through an intermediate member such as a lever for protection.

The inventive concept further includes the option to set the agitating table agitating motion manually or automatically.

The foregoing description is intended for purposes of illustration. The inventive concept may be embodied in other forms or carried out in other ways without departing from the spirit or scope of the inventive concept.

The following patents are incorporated by reference in their entireties: U.S. Pat. No. 8,758,687, 20160122808, U.S. Pat. No. 7,708,946, and D631,555.

While the inventive concept has been described above in terms of specific embodiments, it is to be understood that the inventive concept is not limited to these disclosed embodiments. Upon reading the teachings of this disclosure, many modifications and other embodiments of the inventive concept will come to mind of those skilled in the art to which this inventive concept pertains, and which are intended to be and are covered by both this disclosure and the appended claims. It is indeed intended that the scope of the inventive concept should be determined by proper interpretation and construction of the appended claims and their legal equivalents, as understood by those of skill in the art relying upon the disclosure in this specification and the attached drawings.

1. An automated assay apparatus for performing one or more assay procedures using a liquid reagent and a washer liquid, the apparatus comprising:
a first vial supporting plate;
a first vial adapted to be filled with the liquid reagent, e.g, washer liquid;
a first funnel adapted to accept the liquid reagents;
a first reaction chamber;
a first elastomeric conduit comprising a passageway, a first end of the passageway in communication with the first funnel;
a plurality of parallelly aligned valve members; and
a second end of the passageway communicatively coupled with the first reaction chamber.

2. The automated assay apparatus of claim 1, wherein the first vial supporting plate is adapted to accept the first vial, and further adapted to be inclined to pour the liquid reagent out to the first funnel; and the first elastomeric conduit is adapted to deliver the liquid reagent from the first funnel to the first reaction chamber.

3. The automated assay apparatus of claim 2, wherein the vial supporting plate further comprises at least one first cell member to place the vial, a cut portion to install the vial, the first cell member adapted to compress against the vial body, and side boss members to hold the vial in position during the plate rotation, and lower round boss members used as shafts around which the plate rotates, and upper round boss members used to push the plate and cause the plate to rotate.

4. The automated assay apparatus of claim 2, further comprising a drive mechanism adapted to rotate the vial supporting plate, further comprising a means adapted to rotate the supporting plate of the vials.

5. The automated assay apparatus of claim 1, further comprising a reagent supply vessel filled with a reagent liquid; a plate adapted to cover the first funnel; the cover plate containing a first hollow passageway; a second elastomeric conduit, a first end of the second elastomeric conduit communicatively coupled with the supply vessel, and a second end of the second elastomeric conduit communicatively coupled with the first hollow passageway; the first hollow passageway formed in the cover plate to supply reagent liquid to the first funnel and direct the washer liquid to wash the first funnel walls.

6. The automated assay apparatus of claim 1, further comprising an agitating table to shake the reaction chambers, the agitating table having one round horizontal guide bar adapted to hold and allow the reaction chambers to move in one horizontal direction, and further having a driving mechanism adapted to restrict the rotating motion around the round horizontal bar.

7. The automated assay apparatus of claim 6, wherein the driving mechanism is adapted to supply the agitating table with a combined rotation around the guide bar and longitudinal shaking of the reaction chambers, the driving mechanism having one round horizontal guide adapted to hold and allow the reaction chambers to move.

8. The automated assay apparatus of claim 6, wherein the driving mechanism is adapted to supply the agitating table with selectable motions that involve combining the rotation around the guide bar and the longitudinal shaking, or involve rotating around the guide bar only, or involve longitudinal shaking only, the drive mechanism movable along the agitating cam axis double rectangular cam followers.

9. The automated assay apparatus of claim 8, wherein the agitating cam has a second radial protrusion forming a second cam profile that engages with the first end of a second elongated member.

10. The automated assay apparatus of claim 9, wherein each of a first and the second elongated members is a plastic rod.

11. The automated assay apparatus of claim 10, wherein the first and second valves each include a spring, the springs being torsion springs.

12. An automated assay method for performing one or more assay procedures using a liquid reagent and a washer liquid, the method involving:
processing the liquid reagent and washer liquid through a first vial supporting plate;
a first vial adapted to be filled with the liquid reagent, e.g, washer liquid;
a first funnel adapted to accept the liquid reagent;
a first reaction chamber; a first elastomeric conduit comprising a passageway, a first end of the passageway in communication with the first funnel;
a plurality of parallelly aligned valve members; and
a second end of the passageway communicatively coupled with the first reaction chamber to produce an assay.

13. The automated assay method of claim 12, the method further involving using the first vial supporting plate accepting the first vial, inclining to pour the liquid reagent out to the first funnel; and the first elastomeric conduit delivering the liquid reagent from the first funnel to the first reaction chamber.

14. The automated assay method of claim 13, the method further involving the first cell member compressing against the vial body wherein the vial supporting plate further comprises at least one first cell member to place the vial and a cut portion to install the vial, and side boss members holding the vial in position during the plate rotation, and lower round boss members being used as shafts around which the plate rotates, and upper round boss members pushing the plate and causing the plate to rotate.

15. The automated assay method of claim 13, the method further involving a drive mechanism rotating the vial supporting plate, further involving rotating the supporting plate of the vials.

16. The automated assay method of claim 12, the method further involving filling a reagent supply vessel with a reagent liquid; covering the first funnel with a plate adapted to cover the first funnel; the cover plate containing a first hollow passageway; a second elastomeric conduit, a first end of the second elastomeric conduit communicatively coupled with the reagent supply vessel, and a second end of the second elastomeric conduit communicatively coupled with the first hollow passageway; the first hollow passageway supplying reagent liquid to the first funnel formed in the cover plate and directing the reagent liquid to wash the first funnel walls.

17. The automated assay method of claim 12, the method further involving shaking the reaction chambers comprising an agitating table, the agitating table having one round horizontal guide bar holding and allowing the reaction chambers to move in one horizontal direction, and further having a driving mechanism restricting the rotating motion around the round horizontal bar.

18. The automated assay method of claim 17, wherein the driving mechanism supplies the agitating table with a combined rotation around the guide bar and longitudinal shaking of the reaction chambers, the driving mechanism having one round horizontal guide holding and allowing the reaction chambers to move.

19. The automated assay method of claim 17, wherein the driving mechanism supplies the agitating table with selectable motions that involve combining the rotation around the guide bar and the longitudinal shaking, or involve rotating around the guide bar only, or involve longitudinal shaking only, the drive mechanism moving along the agitating cam axis double rectangular cam followers.

20. The automated assay method of claim 19, wherein the agitating cam engages with the first end of a second elongated member by way of a second radial protrusion forming a second cam profile.
